(19) United States
(12) Patent Application Publication
(10) Pub. No.: US 2012/0025042 A1
(43) Pub. Date: Feb. 2, 2012

(54) APPARATUS FACILITATING MOUNTING OF SOLAR PANELS TO A RAIL ASSEMBLY

(76) Inventors: John Bellacicco, Stamford, CT (US); John Hartelius, Brick, NJ (US); Henry Cabuhay, Morris Plains, NJ (US); Tom Kuster, Clinton, NJ (US); Michael Monaco, Stanhope, NJ (US)

(21) Appl. No.: 12/846,686

(22) Filed: Jul. 29, 2010

(51) Int. Cl. F16M 13/02; F16C 29/02; F16C 29/00

(52) U.S. Cl. 248/214; 384/25; 384/26

(57) ABSTRACT

An apparatus for mounting solar panels to a rail. The apparatus has a body configured to be attached to a solar panel support structure, and arms on opposite sides of the body configured to engage the rail. The arms hold the apparatus on the rail and allows the support structure to move along the length of the rail. The support structure can be in the form of a carrier which holds one or more solar panels, or may be formed as part of a backside of a solar panel.

### FIELD OF THE INVENTION

Embodiments of the invention relate to solar panel installation, and more particularly to mounting structures for enabling a structure supporting one or more solar panels to move along a rail to its desired location.

### BACKGROUND OF THE INVENTION

Solar panel installation traditionally involves installing a foundation system (typically a series of posts or footings), and then mounting individual solar panels to the support frame with brackets or clips. Other, more complicated mounting systems have been proposed with multiple parts and complex assemblies. These mounting structures can be difficult to install and worse, expensive to manufacture. Additional problems can result from the diverse materials used to manufacture such mounting systems.

Generally, a common thread with known installation systems is that each solar panel must be installed by moving equipment, materials, and labor along rows of support structures to mount solar panels on the support structures one-at-a-time. This is a time-consuming process, which becomes increasingly inefficient with larger scale systems.

With demand for large-scale installations growing, a simplified system for solar panel installation is needed.

### BRIEF DESCRIPTION OF THE DRAWINGS

FIGS. 1A-1C are cross-sectional, top, and perspective views showing a first embodiment of a slidable apparatus, which may be used in a solar panel mounting system.

FIGS. 2A-2B are cross-sectional and perspective views showing the FIG. 1A-1C slidable apparatus mounted to a carrier.

FIG. 3A-3C are cross-sectional, top, and perspective views showing a slidable apparatus in a second embodiment.

FIGS. 4A-4B are cross-sectional and perspective views showing the FIG. 3A-3C slidable apparatus mounted to a rail.

FIG. 5A-5C are cross-sectional, top, and perspective views showing a slidable apparatus in a third embodiment.

FIGS. 6A-6B are cross-sectional and perspective views showing the FIG. 5A-5C slidable apparatus mounted to a rail.

FIGS. 7A-7C are cross-sectional, top, and perspective views showing a slidable apparatus in a fourth embodiment.

FIGS. 8A-8B are cross-sectional and perspective views showing the FIG. 7A-7C slidable apparatus mounted to a rail.

FIG. 9 is a cross-sectional view showing a slidable apparatus in a fifth embodiment.

FIG. 10 is a cross-sectional view showing the FIG. 9 slidable apparatus mounted to a rail.

FIG. 11A is a perspective view showing one exemplary solar panel carrier with FIG. 9 slidable apparatuses attached thereto.

FIG. 11B is an alternate perspective view showing an underside of the FIG. 11A carrier.

FIG. 12 is a perspective view showing the FIG. 11A-B carrier mounted to a FIG. 10 rail.

FIGS. 13A-13B are perspective views showing another exemplary solar panel carrier with a FIG. 1A-1C slidable apparatus attached thereto, mounted on rails.

### DETAILED DESCRIPTION OF THE INVENTION

In the following detailed description, reference is made to the accompanying drawings which form a part hereof, and which illustrate specific embodiments of the invention. These embodiments are described in sufficient detail to enable those of ordinary skill in the art to make and use them. It is also understood that structural, logical, or procedural changes may be made to the specific embodiments disclosed herein.

Described herein is a slidable apparatus for use in a mounting system that supports a simplified installation of solar panels. The apparatus is in the form of a moveable “truck” which may be used with a solar panel carrier of the type described in co-pending application Ser. No. 12/______ entitled “A MOUNTING SYSTEM SUPPORTING SLIDABLE INSTALLATION OF A PLURALITY OF SOLAR PANELS AS A UNIT” by John Bellacicco, John Hartelius, Henry Cabuhay, Tom Kuster, Michael Monaco, and Martin Perkins. (attorney docket no. F4500.1001/P1001), filed concurrently with this application, the disclosure of which is incorporated by reference herein.

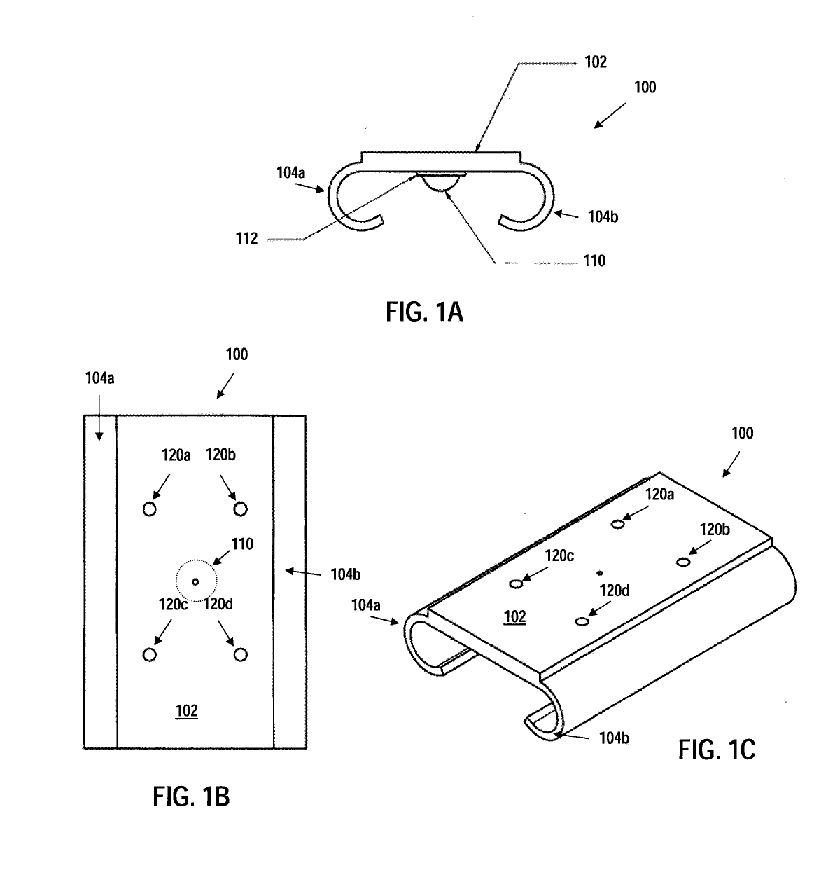

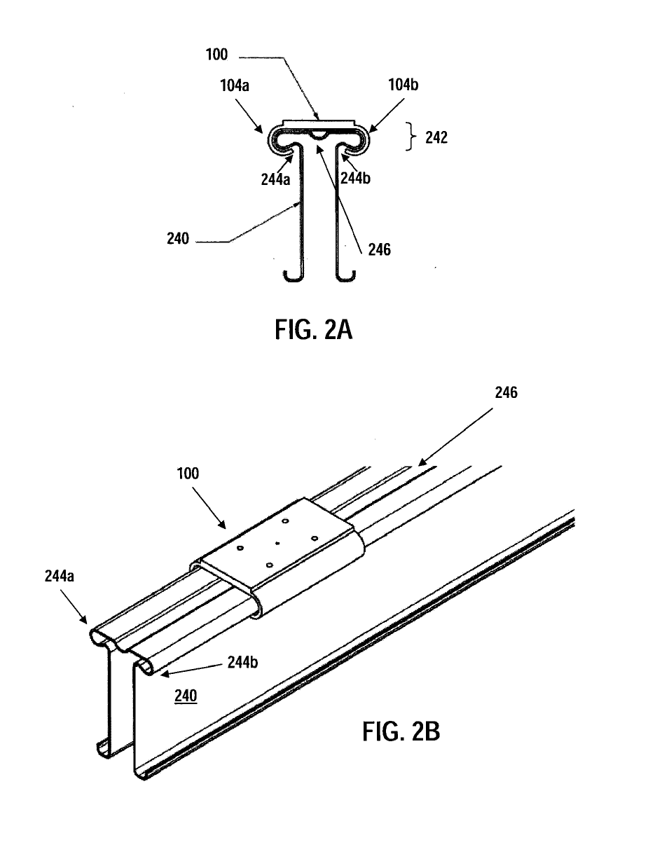

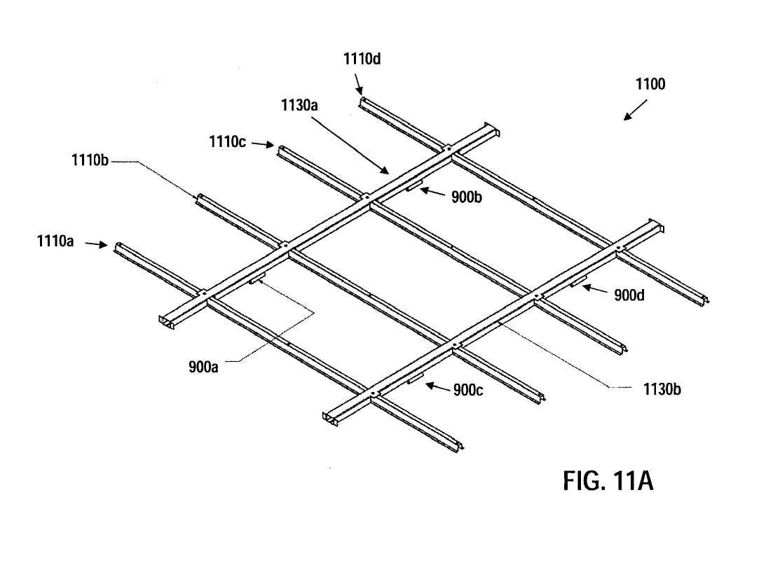

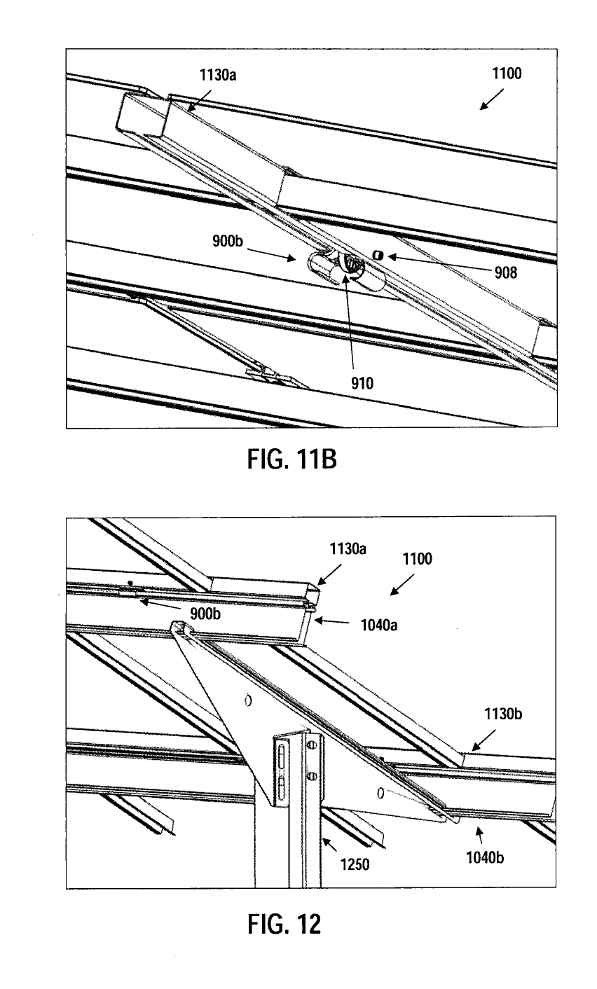

Generally, the truck (embodiments of which are illustrated in FIGS. 1, 3, 5, 7 and 9) is designed to be attached to an underside of a solar panel carrier (exemplary carriers 1100 and 1300 are shown in FIGS. 11A-B and 13A-B), which is intended to hold multiple solar panels together as a single unit and provide a means for installing the solar panels as a unit onto rails in a manual or semi-automated installation system. The trucks, e.g., 900a, 900b, 900c, 900d shown in FIGS. 11A-B and 12, are intended to slidably support the carrier on a rail system. In general, the sliding rail system is comprised of two parallel rails (1040a, 1040b, as shown in FIG. 12) which are mounted one higher than the other from a support surface. When solar panels are installed thereon the rails tilt the panels at a desired angle. Each of rails 1040a, 1040b is attached to a foundation, e.g., 1250. Five examples of rails which can be used are shown in FIGS. 2A-2B (rail 240), 4A-4B (rail 440), 6A-6B (rail 640), 8A-8B (rail 840), and FIG. 10 (rail 1040). Each carrier, e.g., 1100, 1300 has a plurality of trucks, preferably at least 4, fastened to the bottom side of the carrier. Generally, there are at least two trucks per rail per carrier which are designed to slide along the rails so carriers, e.g., 1100, 1300, can be easily moved to a desired location along the rails. The truck is also constructed in such a way that it prevents the carrier from detaching from the rail.

Each truck is capable of sliding along the rail while supporting the carrier dead weight and providing the least amount of frictional resistance. The truck is designed to maintain a low coefficient of friction, preferably less than or equal to 0.15 between the body of the truck (or material applied thereon) and a top surface of a head of the rail, to facilitate movement of a carrier along a rail. Low frictional resistance can be obtained by use of rollers, ball bearings, or low friction materials. Once in the desired location, the slide trucks transfer all imposed loads through the rail structure to the foundation. The trucks are designed so as to not impede any ability to stack or nest the carriers for transit.

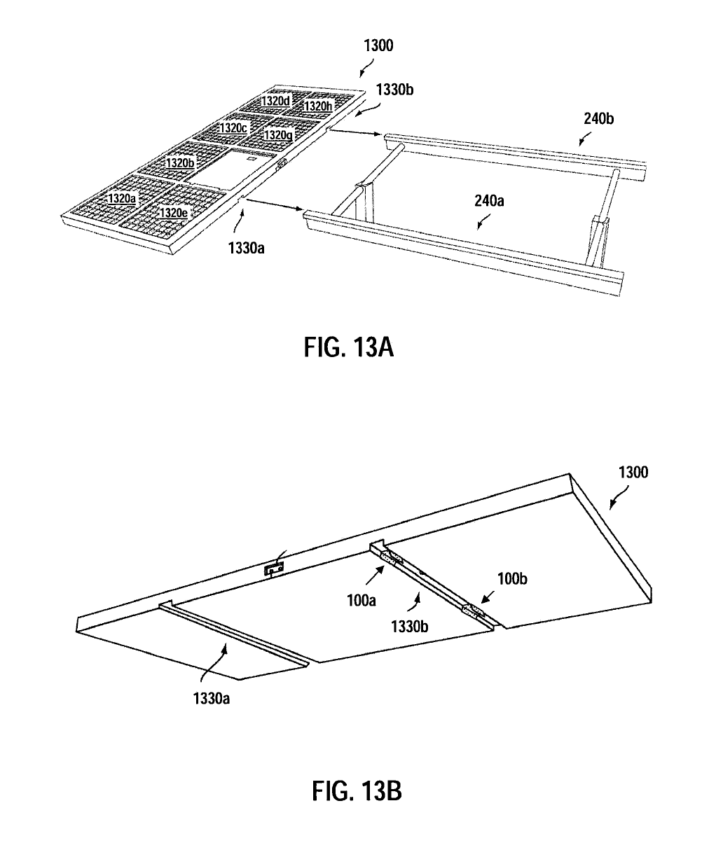

In a first embodiment, shown in FIGS. 1A-1C, truck 100 comprises a body 102 and a pair of arms 104a, 104b on opposite sides of the body 102. The arms 104a, 104b are designed to hold the truck 100 on a rail 240, but allow the truck 100 to slide longitudinally along the rail 240, for example, as shown by rail 240 and truck 100 in FIGS. 2A-213. The arms 104a, 104b can be curved so as to engage the underside of the head 242 of the rail 240 and prevent the truck from moving in any direction except longitudinally. Truck 100 also has a plurality of securing areas 120a, 120b, 120c and 120d for attaching the truck 100 to the underside of a panel mounting carrier, such as the carrier 1100 shown in FIG. 11B or carrier 1300 shown in FIG. 13B. The securing areas 120a, 120b, 120c and 120d shown in FIG. 1 may be holes in the body 102 through which a fastener (not shown) can be inserted, however, it should be understood that the holes 120a, 120b, 120c and 120d could be threaded (for use with screws), or other attachment means could be used to attach the truck 100 to a carrier, e.g., 1300, such as glue, or Velcro®.

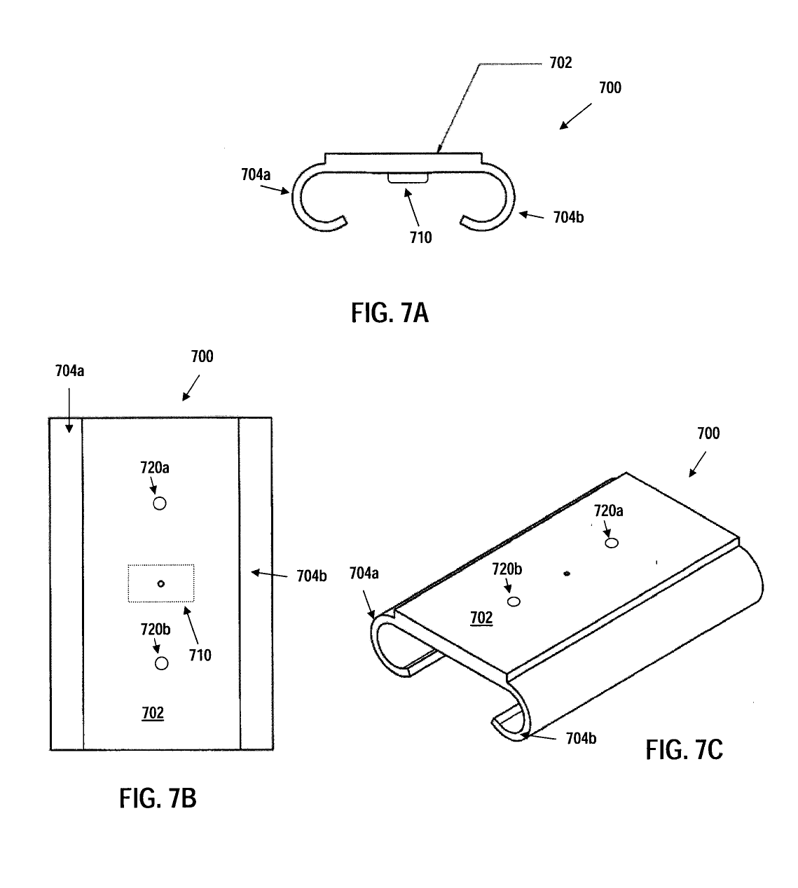

Truck 100 may be configured with a ball bearing 110 mounted on the underside of body 102, as shown in FIG. 1A. The ball bearing 110 is generally partially recessed within body 102 and held in place by a bearing lock 112. As such, body 102 can be thicker than arms 104a, 104b, to accommodate a portion of ball bearing 110 therein. It should be understood that a roller (such as shown in truck 700 in FIGS. 7A-7C) could be used with truck 100 in a similar manner.

FIGS. 2A and 2B show truck 100 mounted on a rail 240 having a head 242. The rail 240 preferably has a T-shaped cross-section, with rail head 242 comprising a pair of flanges 244a, 244b. Flanges 244a, 244b in FIGS. 2A and 2B have rounded ends, but it should be understood they could be rectangular as well. The arms 104a, 104b of truck 100 are designed to surround the head 242 of the rail 240, so as to secure the truck 100 to the rail 240. Rail 240 can also have a rounded groove 246 on a top surface of rail head 242, to engage a ball bearing 110 or other means mounted to or within the truck 100.

Though a T-shaped cross-section of rail 240 is illustrated, it should be understood any cross-section could be used. Generally, such a cross-section could correspond with an interior space defined by the body 102 and arms 104a, 104b of the truck 100.

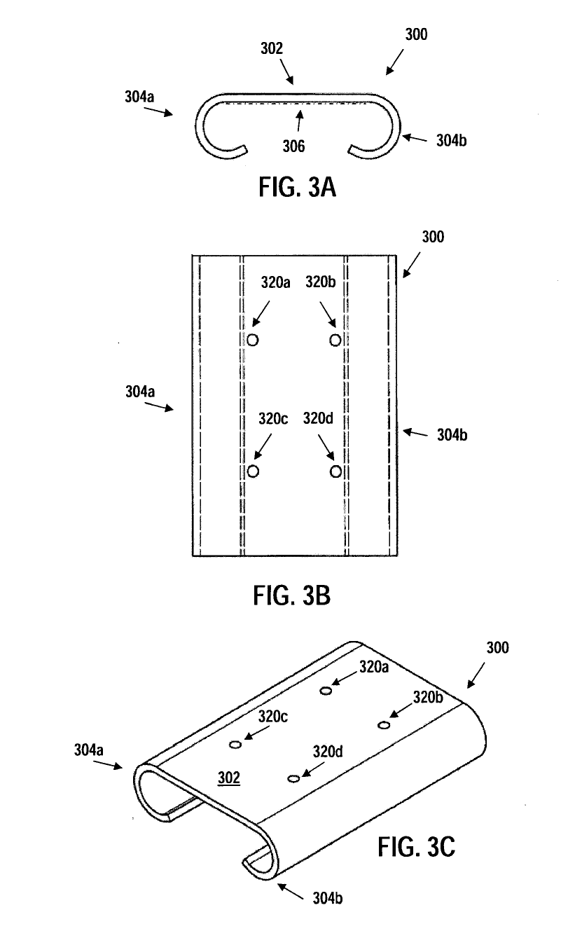

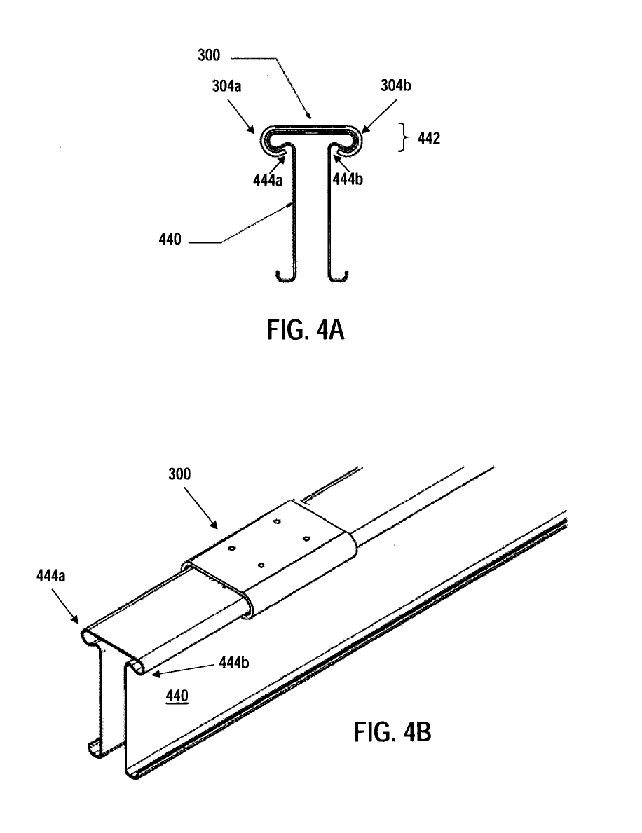

In another embodiment, shown in FIGS. 3A-3C, a truck 300 comprises a body of 302 and curved arms 304a, 304b. As shown here, body 302 and arms 304a, 304b are of the same thickness; truck 300 thus can be made from a single piece of rolled steel. Like truck 100, truck 300 has a plurality of securing areas 320a, 320b, 320c and 320d for securing the truck 300 to the underside of a corresponding carrier 300. Optionally, as shown by dotted lines 306 in FIG. 3A, truck 300 can have a low friction surface attached thereon (such as Teflon®) that allows it to slide along a rail, e.g., rail 440 shown in FIGS. 4A-4B, providing a lower coefficient of friction than if the body 302 contacted the rail 440 directly.

The rail 440 of FIGS. 4A-4B is similar to rail 240 shown in FIGS. 2A and 2B, but without a groove. Truck 300 is shown mounted surrounding the rail head 442, which comprises rounded end flanges 444a, 444b.

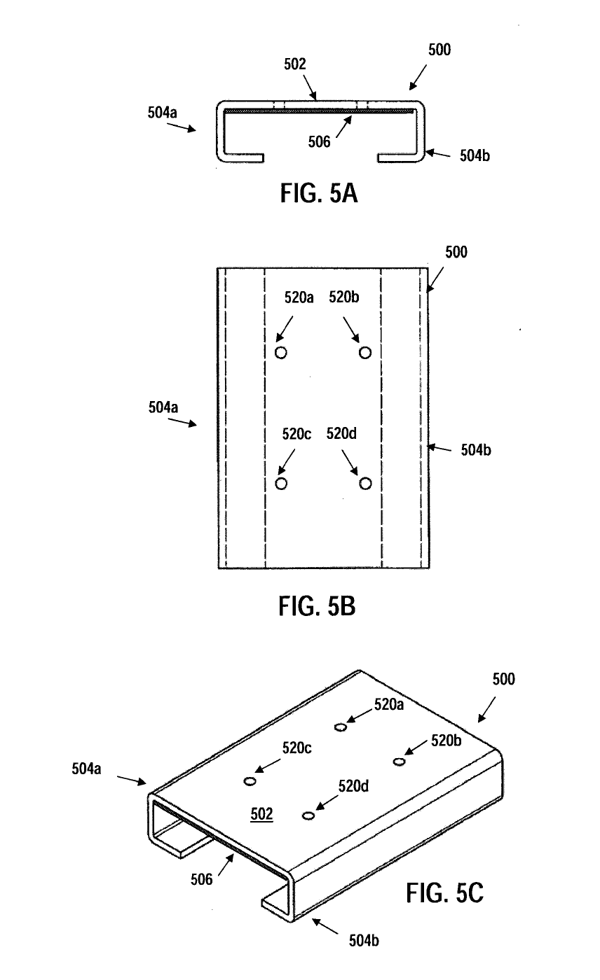

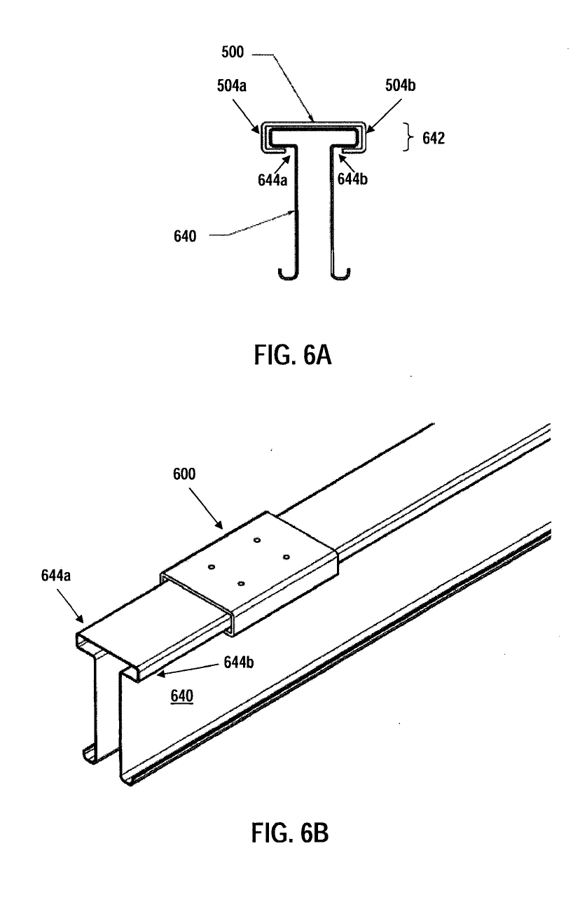

In yet another embodiment, shown in FIGS. 5A-5C, truck 500 has a generally rectangular shape. Like truck 100, truck 500 comprises a body 502 and rectilinear arms 504a, 504b to engage a rail. Truck 500 has a plurality of securing areas 520a, 520b, 520c and 520d, which are the same as the securing areas of trucks 100, 300, for securing the truck 500 to a corresponding carrier, e.g., 1100, 1300. Truck 500 includes a surface 506 of low friction material (such as Teflon®) on the bottom of body 502. As shown in FIGS. 6A and 6B, when truck 500 is mounted on rail 640, surface 506 will contact the head 642 of the rail 640, which has rectangular shaped flanges 644a, 644b.

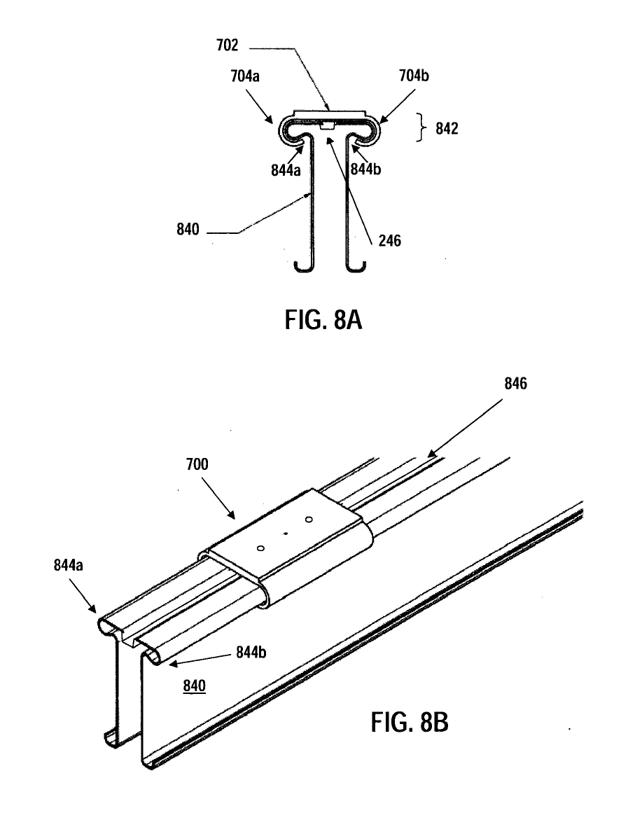

In a further embodiment, shown in FIGS. 7A-7C, truck 700 has one or more rollers 710 inset in body 702. Roller 710 can be, for example, a solid cylindrical structure or hollow wheel. Arms 704a, 704b are curved like those of trucks 100 and 300. Also shown in FIGS. 7A-7C is an arrangement with 2 securing areas 720a and 720b. Since each roller 710 is configured to be aligned with a rectangular groove 846 on a corresponding rail, as shown in FIGS. 8A-8B, the securing areas are arranged so as to be located within that groove 846. Thus, a fastener can be used that is not flush with the bottom surface of the body 702, and it will not interfere with slidability of the truck 700 along a rail. Although the roller 710 in FIGS. 7A-7C is shown to be partially inset into body 702, rollers 710 could also be housed nearly entirely inside body 702, so a groove 846 is not required. In such a case, only the very bottom of roller 710 would extend below the bottom surface of body 702.

The rail 840 of FIGS. 8A-8B is similar to rail 240 shown in FIGS. 2A and 2B, but with a rectangular groove 846. It is understood that the shape of the groove 846 does not have to be rectangular, and can have whatever shape is needed to accommodate truck 700. Truck 700 is shown mounted surrounding the rail head 842, which comprises rounded end flanges 844a, 844b.

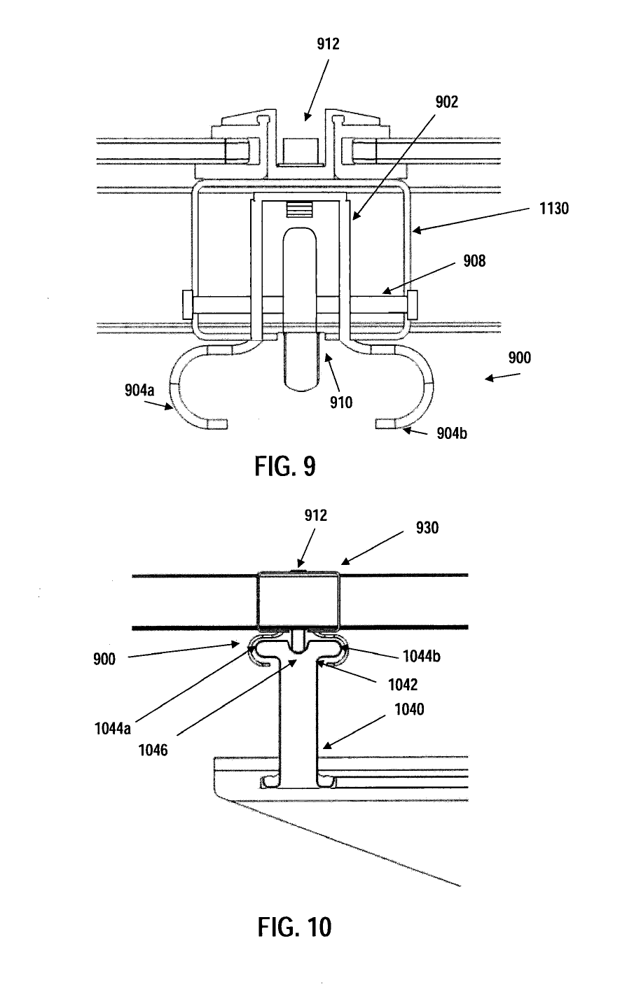

In yet another embodiment, shown in FIG. 9, truck 900 comprises a wheel 910 inset in body 902 suspended via an axle 908 which runs through body 902 and is secured in an attachment structure 1130 of a carrier, e.g., 1100 (as shown in FIG. 11). Wheel 910 can be steel wheel, but it can also be constructed of plastic and rubber. Arms 904a, 904b are curved like trucks 100, 300. The trucks body 902 extends to a top of attachment structure 1130 so as to engage a screw or locking bolt 912 that extends through the attachment structure 1130 and further secures the truck 900 to the carrier 1100.

The rail 1040 of FIG. 10 is similar to rail 240, with rounded groove 846, but is constructed to mate with the FIG. 9 truck such that truck 900 surrounds rail head 1042, which comprises rounded end flanges 1044a, 1044b.

FIG. 11A shows a plurality of FIG. 9 trucks 900a, 900b, 900c and 900d mounted to an exemplary carrier 1100. Carrier 1100 is comprised of a plurality of elongated members 1110a, 1110b, 1110c and 1110d, all connected transversely by attachment structures 1130a, 1130b. The trucks 900a, 900b, 900c and 900d are attached to the bottoms of attachment structures 1130a, 1130b. FIG. 11B is an underside view of the same carrier 1100, showing truck 900b, wheel 910 and axle 908, mounted to attachment structure 1130a.

FIG. 12 shows the FIGS. 11A-B carrier 1100 mounted to a pair of FIG. 10 rails 1040a and 1040b, which are attached to a common foundation 1250.

Another exemplary carrier 1300 with a plurality of solar panels 1320a-g mounted thereon is shown in FIGS. 13A and 13B being mounted to FIG. 2 rails 240a, 240b via attachment structures 1330a and 1330b, which are in the form of grooves in the underside of carrier 1000. FIG. 1 trucks 100a, 100b are shown mounted in attachment structure 1330b.

Mounting carriers, e.g., 1100, 1300, onto associated rails may be accomplished by manually aligning the trucks, e.g., 100, 300, 500, 700, 900 attached to a carrier with the ends of the rails, e.g., 240, 440, 640, 840, 1040, and sliding the carriers into position. Alternatively, a semi-automated carrier mounting and delivery system may be used at the end of each solar array row. One such delivery system is described in more detail in co-pending application Ser. No. 12/______, entitled “AUTOMATED INSTALLATION SYSTEM FOR AND METHOD OF DEPLOYMENT OF PHOTOVOLTAIC SOLAR PANELS, to John Bellacicco, Tom Kuster, Michael Monaco and Tom Oshman (attorney docket no. F4500.1002/P1002), filed concurrently with this application, the disclosure of which is incorporated by reference herein. As discussed in this application, each carrier mounts and supports a plurality of solar panels as a unit, is set on the rails by a robotic system and moved along, thereby simplifying installation time and lowering cost.

Although trucks 100, 300, 500, 700, 900 are shown as being mounted to carriers 1100, 1300, each supporting a plurality of solar panels, trucks can also be mounted to a carrier supporting only one solar panel, or can be mounted directly to the backside of a single solar panel support structure or an individual solar panel, to allow it to be slid along mounting rails.

While several embodiments have been described in detail, it should be readily understood that the invention is not limited to the disclosed embodiments. Rather the embodiments can be modified to incorporate any number of variations, alterations, substitutions or equivalent arrangements not heretofore described. Although certain features have been described with some embodiments of the carrier, such features can be employed in other embodiments of the carrier as well. Accordingly, the invention is not limited by the foregoing description, but is only limited by the scope of the appended claims.

What is claimed as new and desired to be protected by Letters Patent of the United States is:

1. An apparatus for mounting a solar panel to a rail, the apparatus comprising:
a body configured to be attached to a support structure for the solar panel; and
a pair of arms on opposite sides of the body, configured to engage a rail and hold the apparatus to the rail while permitting movement of the support structure along the rail.

2. The apparatus of claim 1, wherein the body has a plurality of securing areas for securing the apparatus to the support structure.

3. The apparatus of claim 2, wherein the securing areas comprise holes in the body through which a fastener apparatus be inserted.

4. The apparatus of claim 1, wherein the arms are configured to surround a head of the rail.

5. The apparatus of claim 4, wherein the arms have a curvilinear cross section.

6. The apparatus of claim 4, wherein the arms have a rectilinear cross section.

7. The apparatus of claim 1, wherein an interior space defined by the arms and body corresponds to a cross-section of a head of the rail.

8. The apparatus of claim 1, further comprising at least one ball bearing on an underside of the body for engaging with a rail.

9. The apparatus of claim 8, wherein the rail has a longitudinal groove and the at least one ball bearing is positioned to engage the groove.

10. The apparatus of claim 1, further comprising at least one roller on an underside of the body.

11. The apparatus of claim 10, wherein the rail has a groove and the at least one roller is positioned to engage the groove.

12. The apparatus of claim 1, further comprising material on a bottom surface of the body providing a lower coefficient of friction with the rail than between the body and rail directly.

13. The apparatus of claim 12, wherein the coefficient of friction between the material and a top surface of a head of the rail is less than or equal to 0.15.

14. The apparatus of claim 1, wherein the support structure is a carrier for holding a plurality of solar panels thereon.

15. The apparatus of claim 1, further comprising at least one wheel mounted within the body on an axle.

16. The apparatus of claim 15, wherein the axle extends through sides of the body.

17. A solar panel assembly comprising:
a rail; and
a truck configured to engage the rail and a solar panel support structure, the truck comprising:
a body configured to be attached to the solar panel support structure; and
a pair of arms on opposite sides of the body to hold the truck on the rail.

18. The solar panel assembly of claim 17, wherein the truck is attached to the solar panel carrier at a plurality of securing areas.

19. The solar panel assembly of claim 18, wherein the securing areas comprise holes in the body of the truck through which a fastener can be inserted.

20. The solar panel assembly of claim 17, wherein the rail has a T-shaped cross section.

21. The solar panel assembly of claim 20, wherein a head of the rail comprises a pair of flanges with rounded ends.

22. The solar panel assembly of claim 17, wherein the arms are configured to surround a head of the rail.

23. The solar panel assembly of claim 17, wherein the arms have a curvilinear cross section.

24. The solar panel assembly of claim 17, wherein the arms have a rectilinear cross section.

25. The solar panel assembly of claim 17, wherein an interior space defined by the arms and body corresponds to a cross-section of a head of the rail.

26. The solar panel assembly of claim 17, further comprising a groove in a top surface of a head of the rail.

27. The solar panel assembly of claim 26, further comprising at least one ball bearing on an underside of the body of the truck, positioned to engage the groove.

28. The solar panel assembly of claim 26, further comprising at least one roller on an underside of the body of the truck, positioned to engage the groove.

29. The solar panel assembly of claim 26, wherein the securing areas are aligned with the groove.

30. The solar panel assembly of claim 26, wherein the groove is rounded.

31. The solar panel assembly of claim 26, wherein the groove is rectangular.

32. The solar panel assembly of claim 17, further comprising material on a bottom surface of the body providing a lower coefficient of friction with the rail than between the body and rail directly.

33. The solar panel assembly of claim 32, wherein the coefficient of friction between the material and a top surface of a head of the rail is less than or equal to 0.15.

34. The solar panel assembly of claim 17, further comprising at least wheel on an axle mounted in the body, positioned to engage the groove.

35. The solar panel of claim 34, wherein the axle is attached to the solar panel support structure.

36. The solar panel assembly of claim 17, wherein the solar panel support structure is a solar panel carrier.

37. The solar panel assembly of claim 36, wherein the solar panel carrier has a plurality of solar panels mounted thereon.

38. The solar panel assembly of claim 37, wherein the solar panel carrier has at least one attachment structure for mounting the carrier on the rail, and the truck is mounted within the attachment structure.

39. The solar panel assembly of claim 38, wherein the truck is secured to the attachment structure through a top surface of the attachment structure.
